(19) United States
(12) Patent Application Publication
(10) Pub. No.: US 2016/0030893 A1
(43) Pub. Date: Feb. 4, 2016

(54) Nanocomposite Membranes

(71) Applicants: Mary Laura LIND, Tempe, AZ (US); Shawn FINK, Chandler, AZ (US); Kenji SASAKI, lake Oswego, OR (US); Jerry LIN, Scottsdale, AZ (US)

(72) Inventors: Mary Laura Lind, Tempe, AZ (US); Shawn Fink, Chandler, AZ (US); Kenji Sasaki, Lake Oswego, OR (US); Jerry Lin, Scottsdale, AZ (US)

(21) Appl. No.: 14/776,598

(22) PCT Filed: Mar. 11, 2014
(86) PCT No.: PCT/US14/23164

§ 371 Date: Sep. 14, 2015

Related U.S. Application Data
(60) Provisional application No. 61/783,822, filed on Mar. 14, 2013.

(51) Int. Cl. B01D 69/14; B01D 71/26; B01D 71/36; B01D 71/48; B01D 71/02; B01D 69/02

(52) U.S. Cl. CPC B01D 69/148; B01D 71/028; B01D 69/02; B01D 71/36; B01D 71/48; B01D 71/26; B01D 2325/12; B01D 2325/02

(57) ABSTRACT

A membrane (100) for liquid separation, where the membrane includes a polymer matrix (110) comprising a thickness (115) and a plurality of water-selectively-permeable particles (120) having a diameter (125) disposed within said polymer matrix, where the thickness substantially the same as the diameter.

### CROSS-REFERENCE TO RELATED APPLICATIONS

This application claims benefit of U.S. Provisional Application No. 61/783,822 filed Mar. 14, 2013; which is incorporated herein by reference in its entirety.

### FIELD OF THE INVENTION

The invention is directed to Molecular Sieve Inclusion NanoComposite (MoSIN) membranes for liquid separations. In particular, MoSIN membranes have high solute selectivity and can withstand harsh chemicals and feed materials. Applications of MoSIN membranes include, but are not limited to osmotic processes (reverse and engineered osmosis) and pervaporation.

### BACKGROUND OF THE INVENTION

Dense, non-porous polymeric membranes are ubiquitous in gas and liquid separations for environmental and energy applications. Examples of such applications include gas separations of methane and hydrogen, osmotic processes for water purification, and pervaporation for separation of volatile organic compounds from water. Two key considerations for membranes are (1) permeability and selectivity, which often represents a design trade-off, and (2) tolerance to “aggressive feeds”, for example, feeds with extreme pHs, temperatures, and oxidizing conditions. Mixed matrix membranes, incorporating nanoparticles into polymeric films, attempt to address these issues. However, many of these membranes are still subject to attack by aggressive feeds.

Fresh water production is one important application area for membranes. Fresh water is essential to human survival and is integral in the global economy for its uses in agricultural irrigation, industrial processes, oil and gas exploration, and electricity production. Continuous population growth and associated development stresses the limited supply of freshwater.

However, water conservation alone cannot resolve the problems of ever-shrinking supply and decreasing quality of surface and ground water. Therefore, production of fresh water from alternative sources such as reclaimed wastewater, brackish groundwater, ocean water, urine, and urine brines is imperative. Currently, osmotic processes such as reverse osmosis (RO) and engineered osmosis (EO) are capable of producing high quality water from these alternative sources.

The separation selectivity and flux performance of existing multi-layer polymeric thin film composite membranes used in osmotic processes is approaching the thermodynamic efficiency limit, leaving little room for improvement in terms of initial raw membrane performance. However, over extended use, osmotic membranes have a propensity to foul with biological material, which reduces overall performance and increases operating costs. Pre-treatment of osmotic feedwaters to mitigate bio-fouling, such as chlorination/de-chlorination and microfiltration, has proved inadequate. In particular, current osmotic membrane materials are vulnerable to degradation by chlorine exposure; this inability to be used with chlorinated waters increases the membranes' fouling propensity.

Chlorine is one of the most common disinfection agents used to inhibit biological growth in water treatment applications. However, osmotic processes require dechlorination of feed waters prior to contact with the osmotic membranes, because chlorine attacks and degrades the chemical structure and performance of current commercially available polyamide-based osmotic membranes.

Urine and urine brines, brackish waters, and wastewaters contain inorganic salts, urea, organic compounds and organic ammonium salts, which can cause fouling.

According to the Department of Energy, in the United States transportation is the second largest consumer of energy behind industrial uses. Specifically, 60% of our annual petroleum use is in the transportation sector; this is equal to the amount of petroleum imported into the country. In 2011, liquid fossil fuels (e.g., petroleum and natural gas) accounted for 54% of the total annual energy consumption in the US. Independence from reliance on imported fossil fuels is imperative to ensure the energy security of our country. Among the wide range of potential renewable energy sources (i.e., wind, wave, solar), biologically derived fuels are a promising, sustainable alternative to liquid fossil fuels. Most importantly, biologically derived liquid fuels are compatible with existing transportation infrastructure; this enables their immediate implementation. A prominent challenge, however, limiting the large-scale production and use of liquid biofuels is effective recovery of the biofuel products from fermentation broths.

The U.S. Department of Energy has identified pervaporation as a promising route to separation of organic fermentation products. Pervaporation is a membrane process, driven by chemical activity differences, that separates miscible liquids by a combination of permeation and evaporation in a dense, semi-permeable membrane. Because the pervaporation process uses membranes, it operates at temperatures lower than the boiling point of the components that are separated (unlike processes such as distillation). Therefore, pervaporation offers a unique route for continuous separation of biofuels from fermentation broths. However, current polymeric pervaporation membranes do not have sufficient flux and selectivity for effective large-scale biofuel recovery. Additionally, membranes need to withstand exposure to corrosive components within the biofuel fermentation bath such as acetone.

What is needed are membranes for pervaporation with high selectivity for transport of biologically derived fuels. Also needed are osmotic membranes that are resistant to harsh materials, such as chlorine or urine, that may be present in feeds.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates Applicants' membrane for liquid separation, comprising a polymer matrix comprising a thickness and a plurality of water-selectively-permeable particles having a diameter disposed within the polymer matrix, wherein the thickness substantially the same as the diameter.

### DETAILED DESCRIPTION OF PREFERRED EMBODIMENTS

This invention is described in preferred embodiments in the following description with reference to the FIGURES, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Applicants' composition of matter comprises molecular sieve inclusion nanocomposite (MoSIN) membranes for liquid separations (including osmotic applications and pervaporation. In forward osmosis water permeates naturally across a semi-permeable membrane to dilute the concentrated draw solution. In reverse osmosis the driving force to transport water across the membrane is an applied pressure greater than the osmotic pressure of the solution.

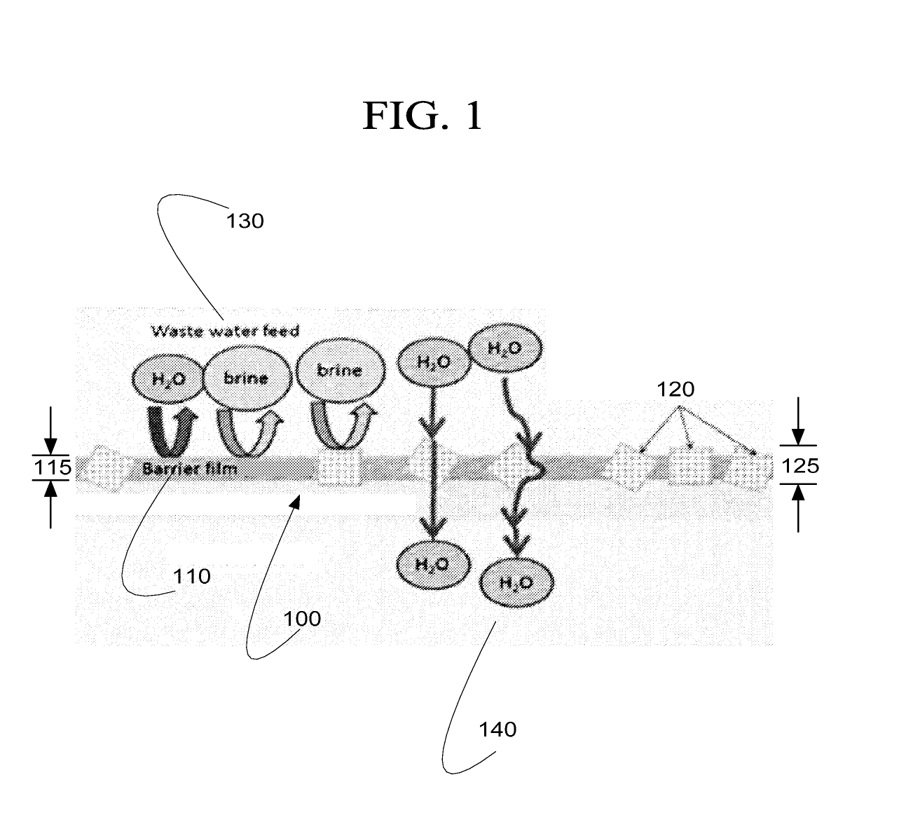

In one embodiment, the composition of matter comprises chlorine tolerant MoSIN membranes for osmotic processes. Referring to FIG. 1, in certain embodiments Applicant's membrane 100 comprises a dispersed layer of water-selective particles 120 within a very thin water-barrier-polymer matrix 110 that is chlorine tolerant; the diameter of the particles 125 is approximately the same as the thickness of the polymer film 115.

Water selective transport will occur through the molecular sieves and/or through a molecular sieve/polymer interface. In certain embodiments, Applicants' MoSIN membrane comprises a polymer thin film matrix of a polymer that binds together a plurality of water-selectively permeable molecular sieve nanoparticles. Suitable polymers for osmotic applications are ones with functionalities resistant to chlorine degradation which include, but are not limited to, minimal aromatic ring, amide linkages, and carboxylic acid functionalities.

In osmotic processes, a semi-permeable membrane separates a more-concentrated solution from a less-concentrated solution. During osmosis, water 130 flows across the semi-permeable membrane 100 from the low concentration to the high concentration solution, diluting the higher concentration solution. This process continues until the chemical potentials of the solutions on each side of the membrane reach equilibrium. The hydrostatic pressure difference between the two solutions of different concentrations is termed the osmotic pressure of the solution.

In reverse osmosis (“RO”), pressure is applied to the more concentrated solution in excess of the osmotic pressure. This applied pressure drives water across the semi-permeable membrane, from the solution of high concentration to the solution of low concentration. An emerging technology, Engineered Osmosis (EO), can be used to perform a low-energy desalination of water or energy production, taking advantage of the entropy of mixing of two streams with different chemical potentials. New EO membranes take advantage of traditional RO polyamide selective layer thin film chemistry; ultimately Applicants new MoSIN thin films can be utilized in EO applications.

All osmotic membranes are semi-permeable; they allow solvent (water in the case of desalination) to pass, but limit solute transport. Currently, the most widely used membranes are based on the pioneering work of Cadotte et. al. These polyamide-based thin film composite reverse osmosis membranes consist of a three-tiered structure: a 2-layer nanofiltration support membrane (a non-woven polyester fabric approximately 50-100 microns in thickness supporting a 50-micron thick phase-inversion cast polysulfone (PSF) layer) provides mechanical support to a polyamide (PA) thin film (30-100 nm in thickness).

In certain embodiments, Applicants deposit MoSIN selective layers, with improved chlorine tolerance, onto the traditional nanofiltration support platform used for osmotic membranes. In certain embodiments, these MoSIN thin films are coated onto a variety of porous support materials, such as electrospun polymer mats, phase inversion cast polymers, porous alumina discs, or track-etched memebranes.

Chlorine is one of the most widely used oxidative disinfectants for water treatment processes as it is capable of significantly limiting the growth of bacteria and other organic materials. In particular, chlorine is important in systems involving wastewater reclamation, which widely incorporate osmotic membranes. However, polyamides, are fundamentally incompatible with chorine and other oxidative reagents.

After exposure to chlorine, polyamide reverse osmosis membrane flux increases and salt rejection decreases. While typical disinfection concentrations of free chlorine in water treatment applications range from 1-5 ppm, commercial membrane manufacturers void RO membrane warranties if the membranes are exposed to more than 0.1 ppm of free chlorine. Because of the ubiquity of polyamide as an osmotic membrane and its vulnerability to chlorine attack, additional pre-treatment steps are taken to de-chlorinate feedwaters before they enter the osmotic desalting processes. These chlorination pre-treatment steps increase both the capital costs and the energy consumption of osmotic processes. Despite the pretreatment steps, membrane fouling still occurs. Allowing chlorine-treated feedwaters to pass through osmotic membranes would result in significant savings in RO pre-treatment costs and reduce membrane fouling propensity.

Two major pathways have been identified by which chlorine attacks and degrades the structure and selective properties of polyamide. First, chlorine is thought to attack the amide linkages in the polyamide structure. Substitution of —Cl for —H can result in cleavage of the amide linkage in the polymeric structure or disruption of hydrogen bonding (by the elimination of the hydrogen) within the polyamide. Second, by nucleophilic attack, chlorine can substitute into the polyamide and can and penetrate into and destroy the aromatic ring structure.

Strategies to develop membranes with features that mitigate chlorine attack include modification of pendant functional groups on polyamides and development of alternate polymers. Still, these membranes do not yet have the water flux and salt rejection required for commercial osmotic processes.

Improvement of chlorine resistance of osmotic membranes is only one avenue of exploration in the ultimate goal of mitigating biological fouling of osmotic membranes. Another area of research for biofouling reduction is the addition of antifouling coatings or functionality to existing membrane surfaces. Applicants' composition and method includes the development of novel chlorine-tolerant RO membranes with the goal of reducing pre-treatment costs and increasing membrane lifetime.

Allowing chlorine-treated feedwaters to pass through osmotic membranes would result in significant savings in RO pre-treatment costs and reduce membrane fouling propensity.

Zeolites are porous crystalline aluminosilicate materials that are considerably more resistant to chlorine and extreme temperatures than polymeric materials. They are considered molecular sieves because they possess pores of dimensions appropriate to distinguish between molecules. Zeolites have different ratios of aluminum to silicon, resulting in different framework and pore network structures. The Al/Si ratio also determines the hydrophilicity of the structure—which is frequently very high. The hydrophilic nature of zeolites makes them strong candidates for water-selective separation applications.

Micron-thick layers of polycrystalline zeolites grown on a variety of supports have been explored for desalination applications. Ultimately, the grain boundaries and defects between the different crystalline domains in these polycrystalline materials result in lower osmotic selectivity than is theoretically predicted for a single crystalline zeolite structure.

Applicants' membranes use the water-selective transport capabilities of hydrophilic zeolites. Applicants method includes dispersing nano-size zeolite crystals throughout a polymer matrix. By filling the void-space between the water-selective nanoparticles with a chlorine tolerant polymer matrix, Applicants membranes avoid the challenges of reduced selectivity that result from the presence of grain boundaries and defects in large polycrystalline zeolite materials.

Advanced mixed-matrix membrane materials, which incorporate a small filler material within a polymeric matrix show improved mechanical, chemical, and thermal stability as well as enhanced separation, reaction, and sorption capacity. Zeolites and carbon molecular sieves have been used in mixed matrix membranes for pervaporation, ion-exchange, and fuel cell applications. In certain embodiments, Applicants' membrane incorporates enough of the filler material to achieve a ‘percolation threshold,’ which describes a continuous flow path through the filler particles from the feed to the permeate side of the membrane. In certain embodiments, Applicants' mixed-matrix membrane structures uses filler particles with characteristic dimensions on the order of nanometers, rather than microns. A benefit of using nano-sized particles is an increase in the surface area interaction between the filler and the matrix.

Pure metal (silver), metal oxide (titanium dioxide, silica), and zeolite molecular-sieve nanoparticles have been incorporated into, and deposited on, polyamide thin films for reverse osmosis applications. In all cases, except for the addition of zeolites to the polyamides, the resultant nanocomposite membranes have exhibited increased flux but decreased selectivity with increased nanoparticle loading; indicating that defect formation in the polyamide thin film is the principle mechanism of flux enhancement.

In certain embodiments, Applicants' membrane comprises Linde type A (LTA) zeolites in a zeolite-polyamide nanocomposite RO membranes resulting in three-dimensional pore structure, super-hydrophilicity, and small pore size. The molecular formula of LTA is Na₁₂[(AlO₂)₁₂ (SiO₂)₁₂].27H₂O. LTA zeolites have a three-dimensional interconnected pore structure; there is a pore opening on each rotational axis of the structure. The diameter of the central pore of the LTA zeolite can range from 3.5-5.0 angstroms, depending on which ion is associated with the framework. When synthesized with sodium ions in the LTA framework, the zeolite central pore size is 4.2 angstroms. This pore size is ideally suited to exclude hydrated ions, such as sodium and chlorine, or small organic molecules such as urea but allow passage of water molecules.

Unlike LTA zeolites, other porous materials, such as carbon nanotubes and different zeolite frameworks, have only one- or two-dimensional pore structures. In composite materials which incorporate particles with 1-D or 2-D pore structures, orientation of the particle is necessary to ensure that the pore structure is accessible for transport. Extensive research effort has therefore been spent fabricating membranes based on aligning carbon nanotubes within a supporting matrix. A benefit of using a material (such as the LTA zeolite) with a three-dimensional pore structure is that it is not necessary to control precisely the alignment of the filler within the matrix to ensure access to the pore network structure.

Applicants' zeolite nanocomposite RO membranes improve membrane performance (increase flux, maintain rejection) by three mechanisms: (1) the zeolite acts as a molecular sieve, with preferential transport of water, (2) the interface between the zeolite and the polymer contributes a slip plane for transport, and (3) inclusion of the zeolite influences the chemical cross-linking structure of the polymer. Applicants have applied the molecular sieving and interfacial transport mechanisms observed in zeolite-polyamide membranes to their novel MoSIN membranes.

Polymeric materials with barrier properties that limit the transport of oxygen and water are used in engineering and commercial applications that range from food storage to protection of sensitive electronic devices. While no polymer material is completely impermeable to all substances, many polymers have very limited permeability to water, and consequently water-soluble contaminants. In certain embodiments, Applicants utilize poly(ethylene terephthalate) (PET), high density polyethylene (HDPE), Polytetrafluoroethylene (PTFE), Perfluoroalkoxy (PFA), or Polyvinylidene chloride (PVDC) as polymeric materials for the polymeric water-barrier matrix because they have (1) limited capacity for water and salt transport (2) resistance to degradation upon exposure to aqueous chlorine solutions and (3) mechanical strength and flexibility.

Applicants have found that polyvinylidene chloride, polymer I, and the condensation polymer, poly(ethylene terephthalate) (PET), polymer II, are prime candidates for the barrier thin film.

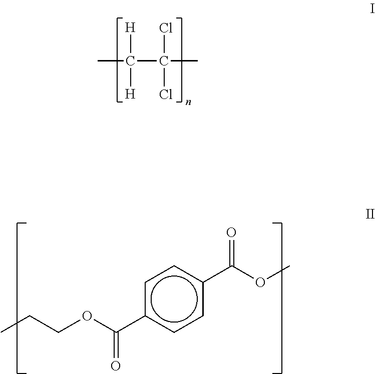

In the bulk form, PET is a water and salt barrier; a common commercial use of PET is in beverage containers. While there are no published reports on the osmotic performance and selectivity of very thin PET films, water diffusivity measurements indicate that PET can act as a barrier to the transport of water and other small dissolved solutes. Transport of water and salt in semi-permeable osmotic membranes is governed by a solution-diffusion mechanism where both the solubility and diffusivity of a component within the membrane material are important parameters for transport. The diffusivity of water in PET was found to be three orders of magnitude lower than the diffusivity of water in polyamide (8.57×10̂−13 m2/s in PET vs. 0.8×10̂−9 m2/s in polyamide). PET has no amine functionality—which has been identified as the primary point for degradation of traditional polyamide membranes.

Applicants have performed water permeation experiments on commercially available 12.7 micron thick PET films. These films exhibited no measurable pure water permeation over a period of 48 hours in a membrane filtration system under an applied pressure of 800 psi. Further experiments have demonstrated that these PET 12.7 micron thick films do not experience any measurable permeability or change in chemical structure (as measured by Attenuated Total Reflectance Fourier Transform Infrared Spectroscopy, ATR-FTIR) after exposure to 5 ppm and 500 ppm free chlorine solutions for 72 hours. These results indicate that very thin films of PET comprise excellent materials for the barrier layer in the MoSIN thin film, because of their barrier nature and chlorine tolerance.

Applicants have deposited approximately 500 nm thick films of PET onto Anodiscs, which are commercially available nanoporous alumina membranes, from solutions of 0.1 wt % PET (McMaster-Carr) dissolved in 70-30 wt % dichloromethane/hexafluoroisopropanol. As purchased, these ˜50 micron thick, Anodiscs have significant pure water permeability (3142 [μm/(s MPa)]) and little solute selectivity. The pure water permeability of the PET-coated Anodisc is 0.0225 [μm/(s MPa)], a factor of 100,000 lower than the pure water permeability of the virgin Anodisc. For comparison, SWC3+, a commercially available polyamide thin film composite membrane, has a pure water permeability of 4.40 [μm/(s MPa)]. This data amounts of draw solute to create the necessary osmotic pressure difference for water recovery.

Applicants have utilized their membrane for water recovery from urine brines primarily though RO. Because urine brines and pre-treated urine are highly acidic, only HDPE and PTFE MoSIN membranes for these solutions (as PET is potentially subject to acid hydrolysis are efficacious with synthetic urine solutions).

The RO system feed was recycled in order to operate at different levels of water recovery. Commercial RO membranes used as controls. demonstrate that a 100 nm thick PET film effectively acts as a water barrier.

High density polyethylene (HDPE), polymer III, is a thermoplastic barrier polymer.

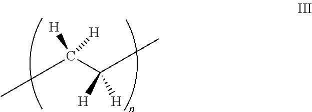

HDPE is defined by having a density of greater than 0.94 g/cm³ and limited branching of the polymer chains. HDPE is widely used as a storage material for a variety of liquids, including chlorinated aqueous solutions. The basic structural unit of HDPE does not have functionalities (amide linkages, aromatic rings) identified to be susceptible to free chlorine attack.

Applicants' permeation tests have found that commercially available 75 micron thick HDPE films have no measurable water transport in a membrane filtration system at applied pressures of 800 psi for 72 hours. Additional FTIR measurements of preliminary chlorine-tolerance tests indicated no change to the chemical structure of HDPE after exposure to 5000 ppm free chlorine for 72 hours.

Previously, Applicants have fabricated pure polyamide and nanocomposite LTA zeolite-polyamide reverse osmosis membranes with both brackish water and seawater performance through an interfacial condensation synthesis method. These thin film polyamide-zeolite nanocomposite membranes exhibited increased water permeability of 10-50% over similarly cast pure polyamide composite membranes while maintaining observed salt rejection greater than 99%. The increase in membrane permeability positively correlated with increased loading of LTA zeolites in the casting solutions. These results indicate that water transport is occurring both through the zeolite as well as through the zeolite-polymer interface.

In certain embodiments, Applicants' membrane comprises Linde Type A zeolite nanoparticles as the porous, inorganic, chlorine tolerant water selective nanoparticle. In certain embodiments, Applicants' MoSIN thin film composite membranes with high surface area loadings of zeolite nanoparticles, have similar water permeabilities to pure polyamide thin film composite membranes, but significantly enhanced chlorine tolerance.

In certain embodiments, Applicants' membranes comprise chlorine tolerant Zeolite Inclusion NanoComposite (ZINC) membranes comprising a monolayer of LTA nanoparticles connected by a chlorine-tolerant polymer matrix on a polymeric support membrane. In certain embodiments, Applicants' membranes comprise a polymeric barrier thin film approximately 100 nm in thickness with limited transport of water or dissolved solutes (salts, ions). In certain embodiments, Applicants' membranes comprise evenly dispersed high weight loadings of water-selective zeolite nanoparticles into a 100 nm polymeric thin film.

In certain embodiments, Applicants deposit a 500 nm film through spray deposition with very limited permeability on a porous substrate.

In certain embodiments, Applicants deposit a 100-900 nm polymer film through latex film formation onto a porous support membranes.

In spin coating, a polymer is dissolved into a solvent and then dropped onto a substrate which is spinning at a fixed angular velocity. By varying the angular velocity, viscosity of the deposition solution, and temperature of the solution, the thickness of the deposited film can be varied from tens of nanometers to microns. While the spinning substrate limits the maximum sample size that can be coated, the size of the substrate is appropriate for lab-scale experiments.

In certain embodiments, Applicants utilize spin coating of PET and HDPE thin films in two distinct steps: (1) deposition onto nonporous supports and (2) deposition onto porous polymeric supports. In certain embodiments, Applicants' method deposits polymeric thin films onto non-porous supports to form a defect-free 50-100 nm polymer film.

In certain embodiments, Applicants method optimizes spin coating fabrication variables including: polymer molecular weight, polymer concentration in solvent, solvent type, spin casting solution temperature, substrate temperature, and substrate spinning speed. In certain embodiments, Applicants' method adjusts certain fabrication conditions to optimize barrier thin film thickness, morphology, uniformity, and composition.

In certain embodiments, Applicants spin coat PET onto nonporous inorganic and metallic substrates: 0.25-5 wt % solutions of PET in trifluoroacetic acid, hexafluoroisopropanol, and 1,1,2,2-tetrachloroethane. HDPE is insoluble in common solvents at room temperature; therefore it must be both dissolved and spin coated at higher temperatures. In certain embodiments, Applicants spin coat HPDE above 100° C. from solution in both decalin and xylene.

Applicants have found that two variables to consider when depositing a barrier polymer onto a porous polymeric support are: (1) the increased roughness of the polymeric support compared to the model nonporous support, and (2) the possibility of seepage of the barrier polymer into the porous support structure. Applicants have characterized these barrier films for osmotic separation performance, and anticipate no flux through the pure barrier.

In certain embodiments, Applicants' MoSIN membrane incorporates a high loading (up to 50-80% of the membrane surface area) of water selective LTA zeolite nanoparticles throughout a chlorine-resistant thin polymeric barrier matrix film. In certain embodiments, Applicants' MoSIN membrane incorporates LTA zeolites comprising diameters of 50 nm, 150 nm, and/or 250 nm. As synthesized, these zeolites are superhydrophilic, which allows for good dispersion of nanoparticles within aqueous and polar solutions. However, in order to achieve better dispersion of the LTA zeolites in organic/nonpolar solvents, the zeolite surface functionality can be altered with the addition of organic groups to have a more hydrophobic character. Applicants have found that organic modification of the zeolite surface increases dispersability of the zeolites within organic solvents as well as increase possible chemical interactions between the zeolite and the surrounding polymer matrix.

In certain embodiments, Applicants' MoSIN membrane comprises zeolites that penetrate the water-barrier matrix and are exposed to the osmotic feed solution. For nanocomposite barrier thin films deposited through spin coating, there are two main challenges to incorporation of porous zeolite nanoparticles: (1) uniform dispersion of nanoparticles throughout the barrier thin film and (2) ensuring zeolite pores are exposed at the surface and not blocked by the barrier polymer.

Applicants' synthetic method (casting solution composition, temperature, substrate rotation speed) for depositing barrier films incorporates both unmodified and organically modified LTA zeolites through two methods. First, pre-seeding of zeolites onto the support layer prior to polymer deposition. Second, incorporation of zeolite through dispersion within the casting solution prior to membrane casting. Pre-seeding of the nanoparticles onto the porous substrate is achieved via spin coating or spray deposition, followed by spin coating of the polymer solution.

Applicants have found that the presence of water associated with the super-hydrophilic LTA zeolites may have the potential to limit barrier polymer encapsulation of the zeolite as a result of the immiscibility between water and the solvents used for the spin coating deposition.

In previous zeolite-polyamide nanocomposite work, Applicants fabricated thin film nanocomposite membranes from solutions with relatively low loadings of zeolite nanoparticles in the casting solutions (0.15-1.5 wt %). Since a key feature of the MoSIN design is to create a final thin film with a very high surface fraction of zeolites (ideally 50-80% of the membrane surface area), in certain embodiments Applicants' MoSIN membranes comprise a larger range of initial solution loading. Applicants utilize analytic techniques, such as TGA, to investigate the actual loading of nanoparticles within the barrier thin films.

Once MoSIN layers have been deposited on porous substrates they are characterized through osmotic performance and microscopy to determine if transport through the particles is blocked. The optimized barrier PET thin films are ˜50 nm in thickness, and therefore, the barrier film blocks the pore openings to the ˜100 nm diameter LTA zeolites. In certain embodiments, the zeolite structure extends entirely through the thickness of the film. In certain embodiments, wherein the nanoparticles are covered with polymer, Applicants utilize chemical and/or plasma etching of the surface to expose the zeolite nanoparticles.

Prior art compositions and method do not fabricate thin films (with a thickness on the order of hundreds of nanometers) of PET or HDPE on polymeric nanofiltration support membranes.

The osmotic performance of Applicants' pure polymeric barrier thin films and MoSIN membranes with synthetic seawater (32 g/L sodium chloride), in a cross-flow cell, with an applied pressure of 800 psi shows no measurable permeation of either water or solutes through pure barrier polymer.

Reference polyamide membranes, barrier films, and MoSIN membranes are exposed to chlorine in an identical fashion. Applicants evaluate the membrane response (osmotic performance and chemical and physical properties) to chlorine exposures of 5, 50, 500, and 5000 ppm each for times of hours to weeks. The reactivity of chlorine towards polyamide membranes has been demonstrated to depend on pH.

Membrane samples exposed to both in-situ and ex-situ chlorination experiments are characterized with ATR-FTIR and X-ray photo electron spectroscopy (XPS), to look for any chemical degradation as a result of chlorine exposure or any bound chlorine. High resolution XPS scan can identify shifts in the type of chemical bonding at the surface layer of the membranes as a result of any interactions with the chlorine.

The results of EDX mapping in conjunction with TGA analysis provide an excellent quantitative analysis of the weight percentage and distribution of LTA nanoparticles within the ZINC membrane.

In another embodiment the Applicants are developing MoSIN membranes for direct recovery of water from urine and urine brine wastewaters through osmotic processes.

Applicants' MoSIN membrane represents a new paradigm in osmotic membrane technology. Applicants' invention includes a MoSIN membrane composition and a method to fabricate a layer of water-selective molecular sieves connected by a water-barrier polymeric film to create a chlorine-tolerant membrane for reverse osmosis. Applicants' composition and method are readily extendable to membranes for other separation applications; these include forward osmosis for water purification and energy production, pervaporation for biologically derived alcohol recovery, and gas separations.

In space missions, urine is a major source of recycled and recovered water. The pH of urine may range from 4.5-8. The majority of urine is water and approximately 5 wt % is composed of inorganic salts, urea, organic compounds, and organic ammonium salts37. The current Water Recovery System (WRS) used by NASA on the International Space Station (ISS) has two major components: (1) the Water Processor Assembly (WPA) and (2) the Urine Processor Assembly (UPA). According to Carter3, input to the UPA consists of pre-treated urine (pH 1.1-2.4, consisting of urine and flush-water pretreated with chromium trioxide and sulfuric acid). The UPA can nominally process 9 kg/day, and it was originally designed to recover 85% of water from pretreated urine. Recently, the UPA has been operated at only 70% recovery3 due to problems with precipitation of calcium sulfate. The non-reusable brine waste that is produced by the UPA consists of 16-19 wt % solids and also has a pH of 1.1-2.43. An increase above the current 70% recovery rate would increase overall water recovery on the ISS and help close the water loop.

Previously, NASA has determined that components fabricated out of PTFE are suitable for extended contact with both pre-treated urine and the brine from the UPA; however, there are no published reports on the compatibility of PET or HDPE with urine and urine brines.

A MoSIN membrane with a surface area of 25% LTA zeolites is expected to have an intrinsic permeability equal to that of commercial seawater RO membranes. While these modest zeolite loadings would yield performance comparable to currently available commercial membranes, our ultimate goal is to fabricate MoSIN membranes with 60% zeolite surface area. Such a membrane has 2.5-7 times the intrinsic permeability of commercial RO and FO membranes.

In addition, MoSIN membranes have very high rejection of dissolved solutes (such as inorganic salts, urea, and other small organic molecules) based on the small pore size of the LTA nanoparticles.

Applicants have developed a new class of corrosion-resistant Molecular Sieve Inclusion Nanocomopsite (MoSIN) membranes and to demonstrate their effectiveness for recovering water from raw urine, pre-treated urine, and urine brine solutions through osmotic processes.

Of utmost importance to our membrane design is ensuring that the pores of the zeolites are accessible (and not blocked) at the surfaces of the MoSIN membrane. The porous, water-selective zeolite molecular sieves provide a single particle percolation pathway through the supporting polymeric film. In certain embodiments, the nanoparticles protrude slightly above the top of the polymer layer.

The composition of urine is complex and is a function of many factors including diet, metabolic demands, and renal activity. The most important consideration for our proposed work is the range of urinary osmotic pressure, calculated to be 0.84-29 atm; this is based on use of the Morse equation and known values for maximal urinary dilution (35 mOsm/L) and concentration (1200 mOsm/L). The concentrated brine from the UPA, with 16-19 wt % solids (depending on the exact concentration of inorganic salts and organic molecules), could have an approximate osmotic pressure between 65-120 atm. In comparison, the osmotic pressure of a 32 g/L NaCl aqueous solution (similar to the Pacific Ocean) is ˜30 atm. Because the concentrated brine waste from the UPA has a high osmotic pressure, a urea-impermeable FO process would require large amounts of draw solute to create the necessary osmotic pressure difference for water recovery.

Therefore, Applicants have explored water recovery from urine brines primarily though RO. Because urine brines and pre-treated urine are highly acidic, only HDPE and PTFE MoSIN membranes are efficacious for these solutions. This treatment was performed using a cross-flow RO testing system. The RO system feed was recycled in order to operate at different levels of water recovery. Commercial RO membranes were used as controls.

In another embodiment, the Applicants are developing Zeolite Imidazolate Framework Inclusion Nanocomposite (ZIFINC) membranes for pervaporation for direct recovery of biologically derived fuels.

Molecular sieves are materials used for a variety of separation and adsorption processes; these include zeolites, metal organic frameworks (MOB), and a subset of MOFs-zeolite imidazolate frameworks (ZIFs). The atomic framework of these materials creates pores with characteristic dimensions on the order of angstroms to tens of nanometers that are appropriately sized to distinguish between molecules.

Zeolites are microporous crystalline materials consisting of an aluminosilicate framework45. Most zeolites are extremely hydrophilic and they have been applied in gas separation, adsorption and catalysis. Silicalite-1 is the aluminum-free analog of the MFI-zeolite framework; it has pore sizes from 5.3 to 5.6 angstroms. Because silicalite-1 is free of hydroxyl groups on the internal pore surface, it is significantly more hydrophobic than its MFI-zeolite analogue. As a result of its hydrophobic nature, silicalite-1 exhibits selectivity for alcohols over water. Pure silicalite has been extensively studied for its alcohol sorption properties and its performance for separation of alcohol-water mixtures through pervaporation.

Metal-Organic-Frameworks (MOFs) have precisely defined pore structures analogous to those of zeolites50. However, unlike zeolites, MOFs are not completely inorganic as they consist of metal-oxide clusters connected by organic linkages51. Zeolite imidazolate frameworks (ZIFs) are a subset of the family of MOFs. ZIFs consist of transition metals connected by imidazolate linkages resulting in frameworks with precisely defined pore structures. Continuous membranes of polycrystalline MOFs and ZIFs have shown excellent fluxes in single gas permeation and high selectivities in two-component separations.

Applicants have explored methods to incorporate hydrophobic ZIF materials, including but not limited to ZIT-8, into water-impermeable polymeric thin film membranes for selective separation of biofuels.

While the preferred embodiments of the present invention have been illustrated in detail, it should be apparent that modifications and adaptations to those embodiments may occur to one skilled in the art without departing from the scope of the present invention as set forth herein.

We claim:

1. A membrane for liquid separation, comprising:
a polymer matrix comprising a thickness; and
a plurality of water-selectively-permeable particles having a diameter disposed within said polymer matrix;
wherein said thickness substantially the same as the diameter.

2. The membrane of claim 1, wherein said polymer matrix is not permeable to water and comprises one or more polymers comprising no amide linkages.

3. The membrane of claim 2, wherein said polymers are selected from the group consisting of polyvinylidene chloride, poly(ethylene terephthalate), high density polyethylene, and polytetrafluoroethylene.

4. The membrane of claim 3, wherein said water-selectively-permeable particles comprise a three-dimensional pore structure.

5. The membrane of claim 4, wherein said water-selectively-permeable particles comprise a pore diameter of between about 3.5 angstroms to about 5.0 angstroms.

6. The membrane of claim 5, wherein said water-selectively-permeable particles comprise a pore diameter of about 4.2 angstroms.

7. The membrane of claim 6, wherein said water-selectively-permeable particles comprise a molecular formula Na₁₂[(AlO₂)₁₂(SiO₂)₁₂].27H₂O.

8. The membrane of claim 1, wherein:
said membrane comprises a surface area;
said membrane comprises a surface area fraction comprising said water-selectively-permeable particles of at least 50 percent.

9. The membrane of claim 8, wherein said membrane comprises a surface area fraction comprising said water-selectively-permeable particles of about 60 percent.

10. The membrane of claim 8, wherein said membrane comprises a surface area fraction comprising said water-selectively-permeable particles of about 80 percent.

11. A method to remove contaminants from an aqueous mixture, comprising:
providing a membrane for liquid separation, comprising a polymer matrix having a thickness and a plurality of water-selectively-permeable particles having a diameter disposed within said polymer matrix, wherein said thickness is substantially the same as the diameter;
removing said contaminants from said aqueous mixture by directing said aqueous mixture through said membrane.

12. The method of claim 11, wherein said polymer matrix is not permeable to water and comprises one or more polymers comprising no amide linkages.

13. The method of claim 12, wherein said one or more polymers are selected from the group consisting of polyvinylidene chloride, poly(ethylene terephthalate), high density polyethylene, and polytetrafluoroethylene.

14. The method of claim 13, wherein said water-selectively-permeable particles comprise a three-dimensional pore structure.

15. The method of claim 4, wherein said water-selectively-permeable particles comprise a pore diameter of between about 3.5 angstroms to about 5.0 angstroms.

16. The method of claim 15, wherein said water-selectively-permeable particles comprise a molecular formula Na₁₂[(AlO₂)₁₂ (SiO₂)₁₂].27H₂O.

17. The method of claim 11, wherein:
said membrane comprises a surface area;
said membrane comprises a surface area fraction comprising said water-selectively-permeable particles of at least 50 percent.

18. The method of claim 11, wherein said directing is performed at ambient pressure.

19. The method of claim 11, wherein said directing is performed at a pressure greater than ambient pressure.

20. The method of claim 11, wherein said aqueous mixture comprises urine.
